(19) United States
(12) Patent Application Publication
(10) Pub. No.: US 2025/0219668 A1
(43) Pub. Date: Jul. 3, 2025

(54) COMMUNICATION APPARATUS AND CASE FOR A COMMUNICATION APPARATUS

(71) Applicant: SONY GROUP CORPORATION, TOKYO (JP)

(72) Inventors: HIKARU TANOUE, TOKYO (JP); MAKI HIRAIWA, TOKYO (JP); MASAAKI MORIYA, TOKYO (JP)

(21) Appl. No.: 18/849,490

(22) PCT Filed: Mar. 17, 2023
(86) PCT No.: PCT/JP2023/010631

§ 371 Date: Sep. 21, 2024

(30) Foreign Application Priority Data
Mar. 31, 2022 (JP) 2022-059923

(51) Int. Cl. H04B 1/3827; H04M 1/02

(52) U.S. Cl. CPC H04B 1/3833; H04M 1/0202

(57) ABSTRACT

A communication apparatus according to an embodiment of the present technology includes a metallic casing, a non-metallic member, and a cover part. A through-window for communication waves to pass therethrough is formed in the metallic casing. The non-metallic member is provided inside the metallic casing and reinforces the metallic casing. The cover part is made of a resin and is formed separately from the non-metallic member and arranged exposed as viewed from outside of the metallic casing to cover the through-window.

### TECHNICAL FIELD

The present technology relates to a communication apparatus that performs communication by communication waves and a case for a communication apparatus.

### BACKGROUND ART

Patent Literature 1 has described a communication apparatus using high-frequency signals. This communication apparatus performs communication by high-frequency signals in the milli-wave zone or the like. In a casing for the communication apparatus, an aperture is formed in a direction of radiation of the high-frequency signals in order for the high-frequency signals to pass therethrough. Moreover, a window made of a material that provides a smaller loss with respect to the high-frequency signals is provided in the aperture (specification paragraphs [0013] and [0023], FIG. 1, and the like in Patent Literature 1).

### CITATION LIST

### Patent Literature

Patent Literature 1: Japanese Patent Application Laid-open No. 2011-146994

### DISCLOSURE OF INVENTION

### Technical Problem

In a case where a window or the like for the communication waves to pass through the casing for the communication apparatus is provided, the window portion stands out, which may deteriorate the apparatus appearance. In addition, finishing or the like for making the window portion unremarkable can increase the manufacturing costs. Therefore, it is desirable to provide a technology that can make the apparatus look good while reducing the manufacturing costs.

In view of the above-mentioned circumstances, it is an object of the present technology to provide a communication apparatus that can make the apparatus look good while reducing the manufacturing costs and a case for a communication apparatus.

### Solution to Problem

In order to accomplish the above-mentioned object, a communication apparatus according to an embodiment of the present technology includes a metallic casing, a non-metallic member, and a cover part.

A through-window for communication waves to pass therethrough is formed in the metallic casing.

The non-metallic member is provided inside the metallic casing and reinforces the metallic casing.

The cover part is made of a resin and is formed separately from the non-metallic member and arranged exposed as viewed from outside of the metallic casing to cover the through-window.

In this communication apparatus, the through-window for the communication waves to pass therethrough is formed in the metallic casing inside which the non-metallic member for reinforcing is provided. The cover part made of a resin that is formed separately from the non-metallic member is arranged exposed to cover the through-window. Accordingly, for example, it is possible to easily configure the cover part that matches the metallic casing and it is possible to make the apparatus look good while reducing the manufacturing costs.

The non-metallic material may be made of a resin. In this case, the resin that makes the cover part may be a resin different from the resin that makes the non-metallic material.

The resin that makes the non-metallic material may be a reinforced resin including a glass filler. In this case, the resin that makes the cover part may be a resin including no glass filler.

The metallic casing and the cover part may each have a machined surface obtained by integrally machining a surface shape thereof.

The machined surface may have a plurality of parallel grooves.

The non-metallic member may have a base part formed to cover the through-window. In this case, the cover part may be connected to outside of the base part.

The base part may have a recess portion formed in the outside of the base part. In this case, the cover part may be formed in the recess portion.

The base part may be formed to cover an inner peripheral surface of the through-window.

The cover part may be formed by injection-molding a resin material in the recess portion.

The cover part may be attached to the outside of the base part.

The metallic casing may have an external surface that is a surface in the outside and a metallic surface may be exposed in at least a portion of the external surface.

The communication apparatus may further include an antenna module that performs communication by the communication waves. In this case, the through-window may be provided at a position to face the antenna module.

The metallic casing may be a frame constituting a flat-plate shaped apparatus and have a side surface portion that constitutes a side surface of the flat-plate shaped apparatus. In this case, the through-window may be formed in the side surface portion.

The communication waves may be electromagnetic waves whose frequencies are in an inclusive range of from 10 GHz to 300 GHz.

A case for a communication apparatus according to an embodiment of the present technology includes a metallic casing, a non-metallic member, and a cover part.

A through-window for communication waves to pass therethrough is formed in the metallic casing.

The non-metallic member is provided inside the metallic casing and reinforces the metallic casing.

The cover part is made of a resin and is formed separately from the non-metallic member and arranged exposed as viewed from outside of the metallic casing to cover the through-window.

### BRIEF DESCRIPTION OF DRAWINGS

FIG. 1 A schematic view showing a configuration example of a communication apparatus according to a first embodiment of the present technology.

FIG. 2 A schematic view showing plane configuration examples of a through-window.

FIG. 3 A schematic view showing an example of finishing the outside of a case.

FIG. 4 A schematic view showing a configuration example of a case for the communication apparatus exemplified as a comparative example.

FIG. 5 A schematic view showing a configuration example of a communication apparatus according to a second embodiment.

FIG. 6 A schematic view showing configuration examples of a cover part that is attached to a metallic casing.

### MODE(S) FOR CARRYING OUT THE INVENTION

Hereinafter, embodiments according to the present technology will be described with reference to the drawings.

### First Embodiment

### <Basic Configuration of Communication Apparatus>

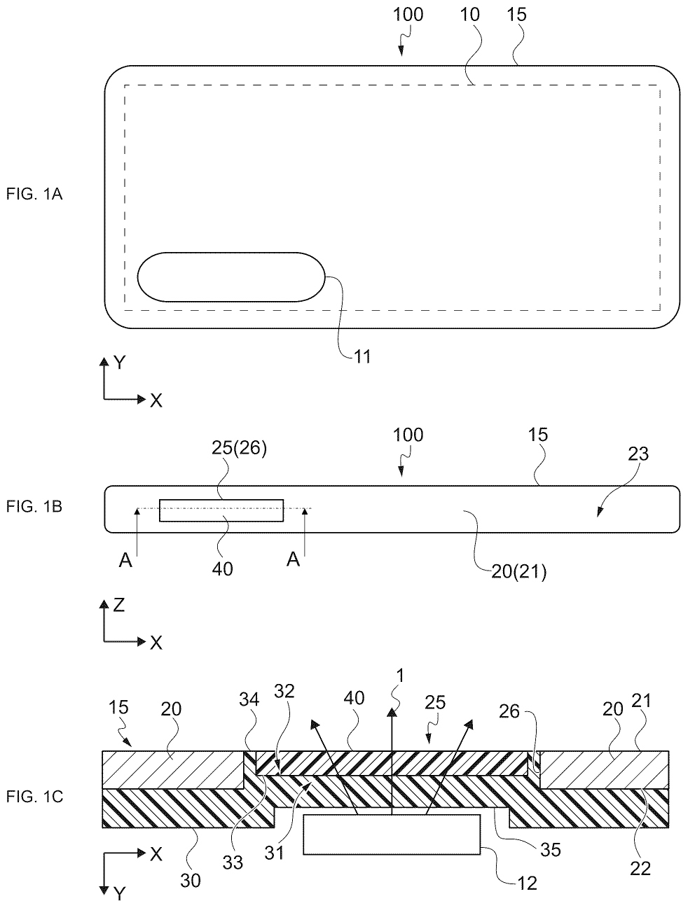

FIG. 1 is a schematic view showing a configuration example of a communication apparatus according to a first embodiment of the present technology. A communication apparatus 100 is an apparatus that performs wireless communication with other apparatuses by sending and receiving communication waves 1. Hereinafter, a portable phone terminal such as a smartphone will be described as an example of the communication apparatus 100. It should be noted that the present technology can be applied to any communication apparatus 100 that performs wireless communication with a tablet terminal, such as a laptop personal computer (PC), a portable WiFi terminal, a portable game console, or a smartwatch.

The communication waves 1 used by the communication apparatus 100 include electromagnetic waves whose frequencies are in an inclusive range of from 10 GHz to 300 GHz. It is known that using the electromagnetic waves whose frequencies are in an inclusive range of from 10 GHz to 300 GHz allows communication at higher speed than in a case where electromagnetic waves for example in the band of less than 10 GHz are used.

For example, in the fifth-generation technology mobile communication system (so-called 5G), electromagnetic waves at the band of 28 GHz is used as the communication waves 1. Although electromagnetic waves with frequencies in an inclusive range of from 30 GHz to 300 GHz are generally called millimeter waves, the communication waves 1 at the band of 28 GHz are also called millimeter waves because their frequencies are near 30 GHz. In the present disclosure, electromagnetic waves including electromagnetic waves whose frequencies are 28 GHz or more will be referred to as millimeter waves. Hereinafter, it is assumed that the communication waves 1 at the band of 28 GHz used in the 5G are used. In this case, the communication apparatus 100 is a smartphone capable of 5G communication, for example. It should be noted that the band of the communication waves 1 is not limited thereto.

The communication apparatus 100 is a flat-plate shaped apparatus whose plane shape is substantially rectangular, for example. Hereinafter, a main surface of the communication apparatus 100 will be referred to as a front surface of the communication apparatus 100 and an opposite main surface thereof will be referred to as a back surface of the communication apparatus 100. Moreover, a longitudinal direction of the main surface of the communication apparatus 100 will be referred to as an X direction, a short-side direction will be referred to as a Y direction, and a thickness direction of the communication apparatus 100 orthogonal to an XY plane will be referred to as a Z direction.

It should be noted that the shape of the communication apparatus 100 is not limited, and can be arbitrarily set.

A of FIG. 1 is a plan view as the communication apparatus 100 is viewed from the back surface. B of FIG. 1 is a plan view as the communication apparatus 100 is viewed from the side surface. C of FIG. 1 is a cross-sectional view of the communication apparatus 100 taken along the AA line shown in B of FIG. 1. The left-hand side in the figure is an upper side of the communication apparatus 100 and the right-hand side in the figure is a lower side of the communication apparatus 100. Moreover, considering a state as the communication apparatus 100 is viewed from the front surface as a basis, the left-hand side and the right-hand side of the communication apparatus 100 will be described. For example, B of FIG. 1 is a right surface of the communication apparatus 100. In A of FIG. 1, the lower side in the figure is the right-hand side of the communication apparatus 100 and the upper side in the figure is the left-hand side of the communication apparatus 100. Moreover, in C of FIG. 1, the lower side in the figure is the left-hand side of the communication apparatus 100 and the upper side in the figure is the right-hand side of the communication apparatus 100.

The communication apparatus 100 includes a communication apparatus main body 10 and a case 15. Moreover, the communication apparatus 100 has a battery (not shown).

The communication apparatus main body 10 is a main body of the communication apparatus 100 and is housed in the case 15 together with the battery. The communication apparatus main body 10 is provided with units (e.g., a CPU, a RAM, a ROM) that constitute a computer, output elements (e.g., a display, a loudspeaker, an LED lamp), input elements (e.g., a touch sensor, a microphone), a sensor element (e.g., a front camera, a rear camera 11, a 9-axis sensor), and a communication element (e.g., an antenna module 12), for example.

In A of FIG. 1, the rear camera 11 provided on a back surface of the case 15 is schematically shown. The rear camera 11 is a camera unit provided on the back surface of the communication apparatus 100. For example, different types of camera sensors are mounted on the camera unit. Each camera sensor is a digital camera including an image sensor, for example, a complementary metal oxide semiconductor (CMOS) or a charge coupled device (CCD). Moreover, the respective camera sensors are different in lens type and image sensor type. The rear camera 11 includes three camera sensors, for example, a ultra-wide-angle lens, a wide-angle lens, and a telephoto lens. In addition, a specific configuration of the rear camera 11 is not limited.

Moreover, in C of FIG. 1, the antenna module 12 provided inside the case 15 is schematically shown. The antenna module 12 is a module that performs communication by the communication waves 1. In the present embodiment, the antenna module 12 is configured to be capable of performing 5G communication in the milli-wave zone, i.e., communication by the communication waves 1 at the band of 28 GHz.

The antenna module 12 is, for example, configured as a package in which an antenna for receiving or sending the communication waves 1 is stored and is a mounting component capable of being mounted on a rigid substrate or a flexible substrate provided in the communication apparatus main body 10. For example, the antenna module 12 storing a thin and long antenna in the package is used. In C of FIG. 1, the antenna module 12 is arranged so that the antenna extends in the X direction.

The case 15 is a member that houses the communication apparatus main body 10. For example, the outer appearance of the case 15 forms the outer appearance of the communication apparatus 100. The case 15 includes a metallic casing 20, a reinforcing member 30, and a cover part 40. Moreover, although it is not shown in FIG. 1, the display is provided on substantially the entire area of a front surface of the case 15. Moreover, a back glass and the like may be provided on the back surface of the case 15.

In the present embodiment, the case 15 is an example of a case for a communication apparatus.

The metallic casing 20 is a member made of metal that is used as an exterior of the case 15. The metallic casing 20 includes an external surface 21 and an inner surface 22. The external surface 21 is a surface oriented outwards in the metallic casing 20. For example, the external surface 21 is a surface visible from the outside as the outer appearance of the communication apparatus 100. The inner surface 22 is a surface oriented inwards in the metallic casing 20. For example, the inner surface 22 is a surface invisible from the outside of the communication apparatus 100.

In the present embodiment, the metallic casing 20 is a frame constituting a flat-plate shaped apparatus. Moreover, the metallic casing 20 has a side surface part 23 constituting the side surface of the flat-plate shaped apparatus. The side surface part 23 is a portion connecting two main surfaces (front and back surfaces) and is configured to surround the entire periphery of the metallic casing 20 with a constant width in the thickness direction. The side surface part 23 constitutes an outer frame of the apparatus. For example, the metallic casing 20 is configured as a frame where a portion in which the display on the front side is fitted and a portion in which the back glass on the back side is fitted are hollow, leaving the outer frame of the apparatus including the side surface part 23.

It should be noted that in a case where no back glass is used, a back surface part made of metal that covers the back surface may be provided. Moreover, a column structure, a surface structure, or the like for keeping the rigidity of the case 15 may be provided inside the metallic casing 20 as appropriate. In addition, the shape of the metallic casing 20 is not limited.

A through-window 25 for the communication waves 1 to pass therethrough is formed in the metallic casing 20. The through-window 25 is an aperture extending through the external surface 21 and the inner surface 22. The through-window 25 is typically a through-hole whose inner periphery is closed. It should be noted that a cutout-like through-window 25 or the like whose inner periphery is partially opened (the inner periphery is not connected) may be provided. In the present disclosure, providing the through-window 25 in the metallic casing 20 in this manner allows transmission and reception of the communication waves 1 without obstructing the metallic casing 20.

For example, the electromagnetic waves in the milli-wave zone including the communication waves 1 at the band of 28 GHz described above are easily shielded by metal. Therefore, it is difficult to send and receive the electromagnetic waves by causing the electromagnetic waves to pass through a member made of metal. In view of this, providing the through-window 25 allows proper transmission and reception of even the communication waves 1 in the milli-wave zone.

As shown in B of FIG. 1, in the present embodiment, the through-window 25 is formed in the side surface part 23. In the example shown in B of FIG. 1, the through-window 25 is provided on the upper side (in the figure, the left-hand side) of the side surface part 23 constituting the right surface of the communication apparatus 100. As a matter of course, the position where the through-window 25 is provided is not limited thereto, and for example, the through-window 25 may be arranged at a position that is a lower side of the left side surface, the upper side surface, or the lower side surface. Providing the through-window 25 in the side surface part 23 allows transmission and reception of the communication waves 1 on the side surface of the communication apparatus 100.

Moreover, as shown in C of FIG. 1, the through-window 25 is provided at a position to face the antenna module 12. For example, the antenna module 12 is arranged in proximity of the side surface part 23 in the communication apparatus main body 10, and the through-window 25 is formed in the side surface part 23 to face the antenna module 12 so as not to block the communication waves 1 radiated from the antenna module 12. It can also be said that the position of the through-window 25 is set in accordance with the position of the antenna module 12 in this manner.

Moreover, the metallic surface of the metallic casing 20 is exposed in at least a portion of the external surface 21. For example, the metallic surface may be exposed in the entire external surface 21 of the metallic casing 20. Here, the metallic surface is, for example, a surface where the metal material is not covered with a coat or the like. Therefore, the metallic surface includes not only a surface where metal is exposed as it is without surface treatment, but also a surface subjected to surface treatment by alumite treatment, for example.

In the example shown in C of FIG. 1, a state in which the external surface 21 of the metallic casing 20 in the periphery of the through-window 25 is exposed as a surface of the case 15 is shown.

The reinforcing member 30 is a member made of non-metallic material that is provided inside the metallic casing 20 and reinforces the metallic casing 20. That is, the reinforcing member 30 functions as a structural member that keeps the rigidity of the metallic casing 20. In the present embodiment, the reinforcing member 30 corresponds to a non-metallic member. The reinforcing member 30 is connected to the inner surface 22 of the metallic casing 20 and is configured to be stored in the casing. In C of FIG. 1, the reinforcing member 30 connected to the inner surface 22 of the metallic casing 20 is schematically shown.

It should be noted that the actual shape of the reinforcing member 30 is, for example, designed in accordance with the inner shape and the like of the metallic casing 20, and a column structure, a surface structure, or the like for keeping the rigidity of the case 15 is provided as appropriate.

The reinforcing member 30 is typically made of a resin. The reinforcing member 30 is configured by injection-molding a resin material in the metallic casing 20, for example. Using the reinforcing member 30 made of a resin makes it possible to relatively easily form a component having a complicated shape and to reduce the total weight of the apparatus.

It should be noted that a resin with relatively high rigidity for providing the function as the structural member for example is favorably used as the reinforcing member 30.

In the present embodiment, a reinforced resin including a glass filler is used as a resin that makes the reinforcing member 30. The glass filler is an additive made of glass which is used added to a resin. For example, glass fibers are used as the glass filler. In this case, the resin that makes the reinforcing member 30 is a glass fiber-reinforced resin. Moreover, a glass filler such as glass beads or glass chips may be used as the glass filler.

For example, polybutylene terephthalate (PBT) is used as the resin material. For example, the PBT has high resistance to anodizing of a molded metal portion and can realize the high-quality reinforcing member 30 because it is a material with high chemical resistance. Moreover, using polyether ether ketone (PEEK) as the resin material can realize the reinforcing member 30 excellent to mechanical characteristics and chemical resistance. Moreover, using polycarbonate (PC) as the resin material can reduce the costs. In addition, the type of resin material is not limited.

As shown in C of FIG. 1, in the present embodiment, the reinforcing member 30 covers the through-window 25 formed in the metallic casing 20. Hereinafter, the portion covering the through-window 25 will be referred to as a base part 31. That is, the reinforcing member has the base part 31 formed to cover the through-window 25. For example, a portion of the reinforcing member 30, which is located immediately below the through-window 25, is the base part 31. Moreover, a region is a flat-surface region of the base part 31, which overlaps the through-window 25 as viewed in the thickness direction (Y direction) of the side surface part 23.

The cover part 40 is a member made of a resin that is formed separately from the reinforcing member 30 and is arranged exposed as viewed from the outside of the metallic casing 20 to cover the through-window 25. That is, the outermost portion of the portion in which the through-window 25 is provided is the cover part 40 as viewed from the outside of the metallic casing 20 (the case 15). In this manner, the cover part 40 is a dedicated member that covers the through-window 25 outside the metallic casing 20.

Moreover, the resin that makes the cover part 40 is a resin different from the resin that makes the reinforcing member 30. Accordingly, it is possible to freely select the resin that makes the cover part 40 separately from the resin that makes the reinforcing member 30 in accordance with the design and the like of the case 15. For example, the resin that makes the cover part 40 is adjusted to be similar to the color and texture of the metallic casing 20. Accordingly, the through-window 25 can be made unremarkable.

For example, the reinforcing member 30 is made of a resin including a glass filler in order to increase the rigidity as the structural member. It is generally known that the glass filler makes the resin whitish. Therefore, a resin including a glass filler like the reinforcing member 30 becomes whitish even if the resin has been controlled to be black.

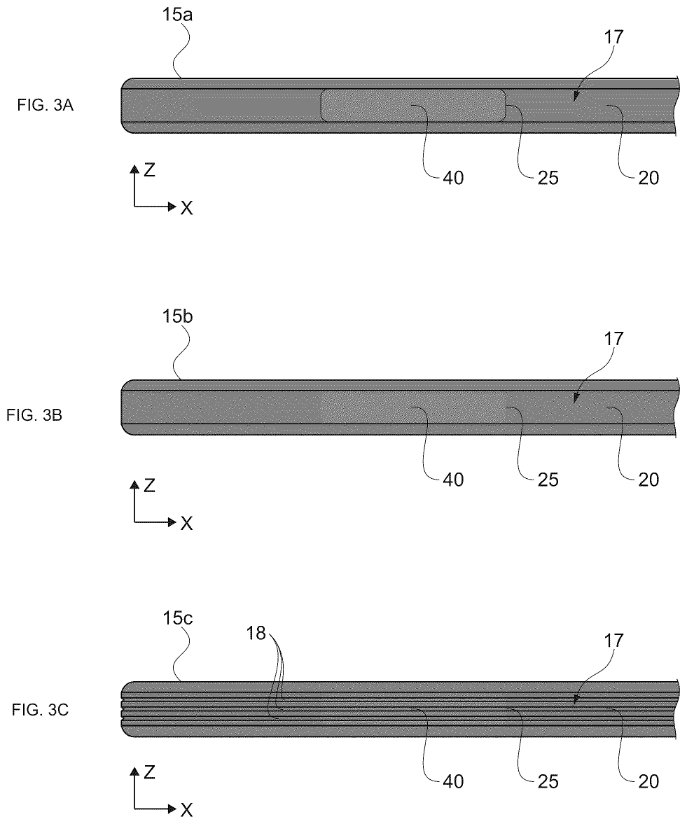

On the other hand, the rigidity of the cover part 40 does not necessarily need to be high. Therefore, a resin including no glass filler can be used as the resin that makes the cover part 40. It prevents the color of the cover part 40 from becoming whitish, and the color of the cover part 40 can be made more similar to the color of the metallic casing 20 (see FIG. 3).

As shown in C of FIG. 1, in the present embodiment, the cover part 40 is connected to the outside of the base part 31 formed on the reinforcing member 30. Therefore, the cover part 40 covers the base part 31 covering the through-window 25 from the inside of the metallic casing 20, from the outside of the metallic casing 20. Moreover, the plane shape of the cover part 40 as viewed in the thickness direction (Y direction) of the side surface part 23 is set to cover substantially the entire surface of the through-window 25. Therefore, the reinforcing member 30 can be hardly seen from the outside of the communication apparatus 100.

Accordingly, for example, the cover part 40 that matches the color and texture of the metallic casing 20 can be used to cover the through-window 25, and the apparatus can be made to look good. Moreover, it is unnecessary to coat the entire case 15 in order to make the cover part 40 unremarkable, and the manufacturing costs can be reduced.

It should be noted that as it will be described later, in the present embodiment, the plane shape of the cover part 40 is set to be slightly smaller than the plane shape of the through-window 25. Therefore, the reinforcing member 30 is slightly exposed between the cover part 40 and the through-window 25.

### <Configuration of Base Part>

Here, a configuration of the base part 31 will be described in detail.

As shown in C of FIG. 1, in the present embodiment, the base part 31 has a recess part 32 formed in the outside of the base part 31. The recess part 32 is a portion depressed inwards in the outside of the base part 31. Here, the recess part 32 having a bottom surface 33 depressed by a constant depth is formed in the external surface 21 of the metallic casing 20 in the side surface part 23. Hereinafter, a portion surrounding the bottom surface 33 (the recess part 32) and projecting outwards with respect to the bottom surface 33 will be referred to as an outer edge portion 34 of the recess part 32.

Moreover, in the present embodiment, the base part 31 is formed to cover an inner peripheral surface 26 of the through-window 25. Here, the inner peripheral surface 26 of the through-window 25 is a surface surrounding the through-window 25 formed in the thickness direction (Y direction in C of FIG. 1) of the metallic casing 20. Conversely, it can also be said that the portion surrounded by the inner peripheral surface 26 is the through-window 25. In the present embodiment, the outer edge portion 34 surrounding the recess part 32 is configured to have a thickness reaching the external surface 21 and the outer edge portion 34 covers the inner peripheral surface 26 of the through-window 25.

In this manner, the base part 31 has a structure in which, for example, in a state in which the through-window 25 is closed by the reinforcing member 30 to reach the external surface 21 of the metallic casing 20, the recess part 32 having a plane shape slightly smaller than the plane shape of the through-window 25 is formed outside the portion where the through-window 25 is closed.

With this configuration, the reinforcing member 30 (the cover part 40) comes into contact with not only the inner surface 22 of the metallic casing 20 in the periphery of the through-window 25, but also the inner peripheral surface 26 of the through-window 25. For example, when forming the reinforcing member 30 inside the metallic casing 20, surface treatment for increasing the waterproof property (e.g., treatment of forming on the metallic surface a bonding film for increasing the strength of bonding with the resin) is performed between the metallic casing 20 and the reinforcing member 30. Such treatment can be, for example, treatment using TRI System (registered trademark). In addition, any surface treatment for enhancing the waterproof property may be performed. In the configuration shown in C of FIG. 1, the effect of such surface treatment is maintained on not only the inner surface 22 of the metallic casing 20, but also the inner peripheral surface 26 of the through-window 25. Accordingly, the waterproof performance in the periphery of the through-window 25 can be maintained at a high level.

Moreover, in the present embodiment, the cover part 40 is formed on the above-mentioned recess part 32. As shown in C of FIG. 1, the cover part 40 is formed to fill the entire recess part 32. Therefore, here, the plane shape of the recess part 32 (the bottom surface 33) is the plane shape of the cover part 40. The plane shape of the cover part 40 (the recess part 32) is slightly smaller than the plane shape of the through-window 25, and the annular outer edge portion 34 (the reinforcing member 30) is exposed between the cover part 40 and the through-window 25 as viewed from the outside of the metallic casing 20. The width of the outer edge portion 34 is set to be as small as possible, for example, within a range that can provide the above-mentioned waterproof performance effect or a range of the molding accuracy of the reinforcing member 30. As a result, the region in which the through-window 25 is provided is almost entirely covered with the cover part 40 as viewed from the outside, and the through-window 25 can be made sufficiently unremarkable.

Moreover, in the present embodiment, the cover part 40 is formed in the recess part 32 by injection-molding the resin material. That is, in the present embodiment, the case 15 is formed by two-color molding of injection-molding two kinds of different resin materials (the reinforcing member 30 and the cover part 40). For example, the reinforcing member 30 is formed by placing the metallic casing 20 in a first mold and injecting a reinforced resin including a glass filler. Next, the cover part 40 is formed by placing a member obtained by bonding the metallic casing 20 and the reinforcing member 30 in the second mold and injecting a resin for the cover part 40 into the already formed recess part 32. Accordingly, the cover part 40 can be accurately formed.

### <Plane Configuration of Through-Window>

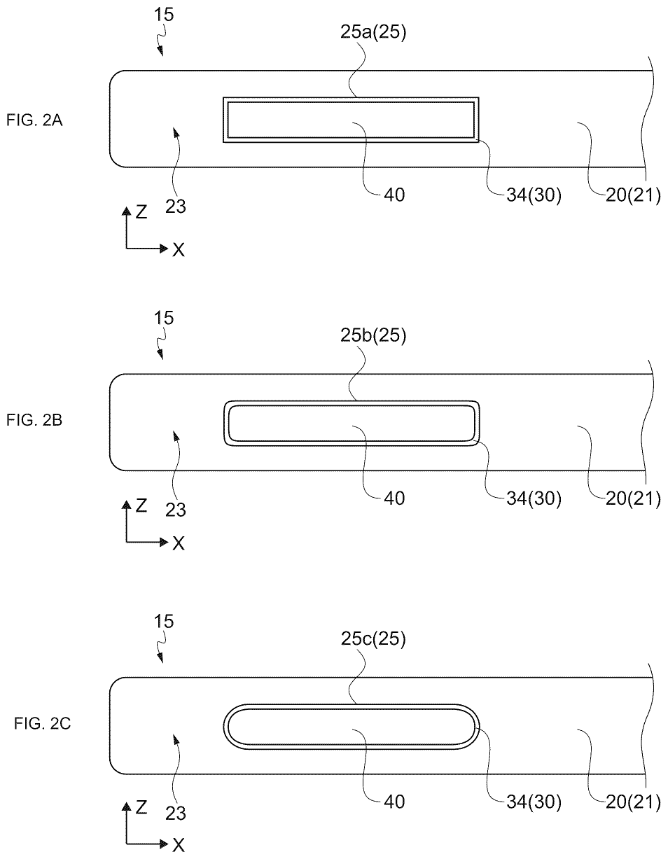

FIG. 2 is a schematic view showing plane configuration examples of the through-window 25. In A of FIG. 2, B of FIG. 2, and C of FIG. 2, plan views of the through-window 25 provided in the side surface part 23 of the metallic casing 20 and the cover part 40 that covers the through-window 25 are schematically shown. In each figure, the outer edge portion 34 surrounding the recess part 32 provided with the cover part 40 can be seen between the through-window 25 and the cover part 40.

In A of FIG. 2, a through-window 25a whose plane shape is a rectangular shape is configured. Moreover, in B of FIG. 2, a through-window 25b whose plane shape is a rectangular shape with rounded corners is configured. In this manner, four corners of the rectangular window may have a constant curvature. Moreover, in C of FIG. 2, a through-window 25c whose both ends having a rectangular plane shape are formed in a semi-circle shape is configured. In this manner, both ends of the through-window 25 in the longitudinal direction may have a constant curvature. In addition, the design of the plane shape of the through-window 25 is not limited.

Moreover, lengths of the through-window 25 in an upper-lower direction (X direction) and a front-rear direction (Z direction) are set in accordance with, for example, the size of the antenna module 12 and the distance between the antenna module 12 and the through-window 25. For example, the lengths of the through-window 25 in the X direction and the Z direction are set to be substantially equal to or larger the lengths of the antenna module 12 in the X direction and the Z direction.

Moreover, the lengths of the through-window 25 in the X direction and the Z direction are set to increase as the distance between the antenna module 12 and the through-window 25 increases. It is because the communication waves 1 radiated from the antenna module 12 are wider as the distance from the antenna increases. Moreover, the through-window 25 is configured to not block the communication waves 1 in accordance with the radiation angle and the like of the communication waves 1 radiated from the antenna module 12.

It should be noted that in the example shown in C of FIG. 1, a recess part 35 with a size that can arrange the antenna module 12 is provided inside the base part 31 that is the reinforcing member 30 that closes the through-window 25. Accordingly, the antenna module 12 can be arranged to be closer to the through-window 25, and therefore the lengths of the through-window 25 in the X direction and the Z direction can be reduced. Accordingly, the through-window 25 (the cover part 40) can be made unremarkable.

### <Finishing of Exterior of Case>

FIG. 3 is a schematic view showing an example of finishing the exterior of the case. In A of FIG. 3, B of FIG. 3, and C of FIG. 3, the side surface part 23 including the metallic casing 20 and the cover part 40 (the through-window 25) is an example of the outer appearance of the cases 15a, 15b, and 15c subjected to finishing is schematically shown.

In all of A of FIG. 3, B of FIG. 3, and C of FIG. 3, the external surface 21 of the metallic casing 20 is subjected to black alumite treatment. Moreover, in A of FIG. 3, B of FIG. 3, and C of FIG. 3, a resin whose color has been adjusted in accordance with the color of the metallic casing 20 subjected to alumite treatment is used as the cover part 40. Here, the color of the metallic casing 20 subjected to alumite treatment is schematically shown in dark gray. Moreover, the resin color used in the cover part 40 is schematically shown by using gray slightly lighter than the gray representing the color of the metallic casing 20.

In the present embodiment, a machined surface 17 obtained by integrally machining each surface shape is formed in each of the metallic casing 20 and the cover part 40. Here, machining of the surface shape is machining of changing the physical shape of the surface by polishing, cutting, or the like. Such machining is performed on both the metallic casing 20 and the cover part 40 at a time. Accordingly, it is possible to work the surface shape of the metallic casing 20 and the surface shape of the cover part 40 in a similar manner, and the cover part 40 can be made sufficiently unremarkable.

In A of FIG. 3, B of FIG. 3, and C of FIG. 3, the entire surface of the side surface part 23 becomes the machined surface 17.

In the case 15a shown in A of FIG. 3, blasting is performed in a state in which the cover part 40 has been provided on the metallic casing 20. The blasting (blasting treatment) is, for example, machining of forming irregularities on the surface by spraying an abrasive to the surface. In this case, the machined surface 17 is a blasted surface. Alumite treatment is performed on the machined surface 17 blasted in this manner.

Accordingly, the surface of the case 15 subjected to alumite treatment is a delustered mat surface. Moreover, in A of FIG. 3, blasting is performed on the cover part 40 made of a resin adjusted to have substantially the same color as the metallic casing 20 in a similar manner to that for the metallic casing 20, and therefore the textures of the metallic casing 20 and the cover part 40 become similar to each other. Accordingly, the cover part 40 becomes unremarkable.

In the case 15b shown in B of FIG. 3, cutting is performed in a state in which the cover part 40 has been provided on the metallic casing 20. The cutting is, for example, machining the cut surface with a cutting tool such as an end mill. Here, cutting to cut the surface into a flat surface is performed. In this case, the machined surface 17 becomes a cut surface cut into a flat-surface shape. Alumite treatment is performed on the machined surface 17 cut into a flat-surface shape in this manner.

Accordingly, the surface of the case 15b subjected to alumite treatment is a lustrous mirror surface. Moreover, since the metallic casing 20 and the cover part 40 are integrally cut in B of FIG. 3, for example, it is more difficult to see the boundary portion between the metal and resin as compared to the case 15a shown in A of FIG. 3. Accordingly, the cover part 40 becomes unremarkable.

In the case 15c shown in C of FIG. 3, cutting to add a stereoscopic texture to the surface of the side surface part 23 is performed in a state in which the cover part 40 has been provided on the metallic casing 20. Here, cutting to form parallel grooves (parallel grooves 18) in the outer peripheral direction (here, the X direction) of the case 15c is performed. In this case, the machined surface 17 becomes a surface having a plurality of parallel grooves 18. Therefore, the cross-sectional shape of the machined surface 17 is a wave-shaped concave-convex shape. Alumite treatment is performed on the machined surface 17 cut into the wave-shape in this manner. It should be noted that blasting or the like may be performed after the cutting to form the parallel grooves 18.

The plurality of parallel grooves 18 forms stereoscopic steps in the side surface part 23, which can be seen by eyes. Due to such a stereoscopic structure, the difference between the cover part 40 and the metallic casing 20 becomes sufficiently unremarkable on the surface of the case 15c subjected to alumite treatment. As a result, it is difficult to distinguish both. Accordingly, it is possible to realize outer appearance specific to the metallic casing 20, which looks expensive, while allowing the presence of the cover part 40 to be hardly perceived. Moreover, such stereoscopic structure machining can be performed as a step of the machining steps for the surface shape, for example, flattening and chamfering of the side surface part 23, and therefore it can be introduced at low cost without increasing the number of steps.

It should be noted that although the case where the parallel grooves 18 (horizontal parallel grooves 18) in the outer peripheral direction of the case 15 are provided has been described herein, the stereoscopic shape formed on the machined surface 17 is not limited thereto. For example, grooves (vertical parallel grooves) orthogonal to the outer peripheral direction may be formed or grooves may be formed obliquely. Moreover, curve line-shaped grooves may be formed.

Moreover, not limited to the cutting, the stereoscopic shape may be configured by knurling or the like. For example, a knurled pattern of crossed lines may be used. Moreover, a knurled pattern or the like that forms for example straight lines (vertical parallel grooves) or angled lines (oblique parallel grooves) may be used.

Hereinabove, in the communication apparatus 100 according to the present embodiment, the through-window 25 for the communication waves 1 to pass therethrough is formed in the metallic casing 20 inside which the reinforcing member 30 for reinforcing is provided. The cover part 40 made of a resin formed separately from the reinforcing member 30 is arranged exposed to cover the through-window 25. Accordingly, for example, it is possible to easily configure the cover part 40 that matches the metallic casing 20 and it is possible to make the apparatus look good while reducing the manufacturing costs.

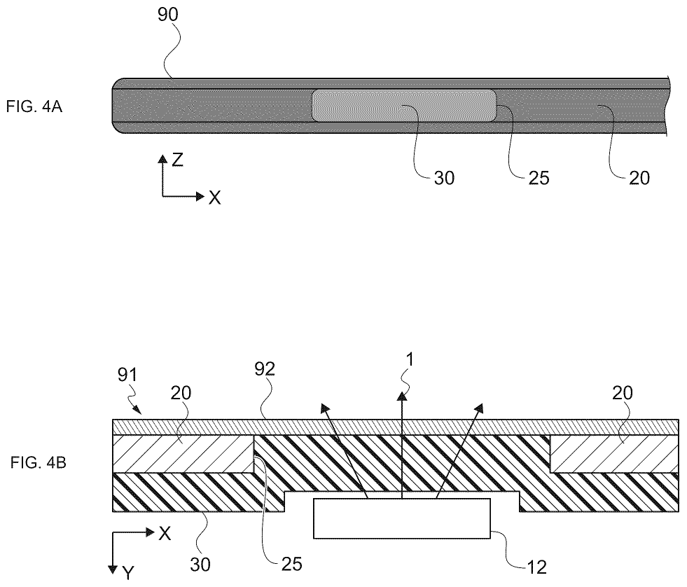

FIG. 4 is a schematic view showing a configuration example of a case for a communication apparatus shown as a comparative example.

In a case 90 shown in A of FIG. 4, no cover part is provided and the through-window 25 formed in the side surface of the case 90 is closed by the reinforcing member 30 provided in the metallic casing 20. In this configuration, for example, even if the color of the reinforcing member 30 is made similar to the color of the metallic casing 20, it looks whitish because the reinforcing member 30 includes a glass filler and the like. As a result, the through-window 25 stands out, which may make the apparatus look bad.

Moreover, in a case 91 shown in B of FIG. 4, the reinforcing member 30 is used to close the through-window 25 as in A of FIG. 4, and in order to make the through-window 25 unremarkable, coating treatment of applying a coating agent 92 to the entire surface of the case 91 is performed. Accordingly, although the portion where the through-window 25 is closed becomes unremarkable, the outer appearance specific to a metal material, which looks expensive, and the like cannot be realized because the surface of the metallic casing 20 is also coated with the coating agent 92. Moreover, it is necessary to perform additional coating treatment after surface treatment (cutting or blasting) of the metallic casing 20 or the like, which can increase the manufacturing costs.

Although the through-window 25 provided in the metallic casing 20 for the communication waves 1 to pass therethrough in the present embodiment is covered with the cover part 40 made of a resin configured separately from the reinforcing member 30. Using the cover part 40 in this manner can make the through-window 25 unremarkable easily at low cost.

Moreover, the cover part 40 is made of a resin different from the material of the reinforcing member 30, and does not include an additive such as a glass filler. Therefore, for example, the cover part 40 does not look whitish unlike the reinforcing member 30. Accordingly, the color and texture of the cover part 40 can be made sufficiently similar to the color and texture of the metallic casing 20.

For example, as shown in A of FIG. 3, B of FIG. 3, and C of FIG. 3, the cover part 40 and the metallic casing 20 can have similar plane shapes by integrally machining them. In this case, for example, only the cover part 40 does not look whitish, and therefore for example, the cover part 40 can be made sufficiently unremarkable as compared to for example a case where the reinforcing member 30 closes the through-window 25 (see A of FIG. 4).

In particular, as shown in C of FIG. 3, in the configuration in which stereoscopic structure is integrally provided on the cover part 40 and the metallic casing 20, the cover part 40 and the metallic casing 20 can hardly be distinguished. Since the cover part 40 becomes sufficiently unremarkable in the step of machining the surface shape in this manner, the manufacturing costs can be reduced.

Moreover, in the present embodiment, the cover part 40 is unremarkable, and therefore it is unnecessary to perform an application step. Accordingly, it is possible to use the metallic casing 20, exposed without coating it, and it is possible to realize a design that looks expensive making use of the metal texture. Moreover, the manufacturing costs for the communication apparatus 100 can be reduced because it is unnecessary to introduce the coating step and a coating agent is also unnecessary. Accordingly, that can make the apparatus look good while reducing the manufacturing costs.

### Second Embodiment

A communication apparatus according to a second embodiment of the present technology will be described. Hereinafter, descriptions of portions with configurations and actions similar to those in the communication apparatus 100 described in the above embodiment will be omitted or simplified.

In the above-mentioned embodiment, the example in which the cover part 40 is formed by injection-molding the base part 31 (the recess part 32) that is the reinforcing member 30 that covers the through-window 25 has been described. A method of providing the cover part 40 is not limited. In the present embodiment, the cover part 40 is attached to the outside of the base part 31.

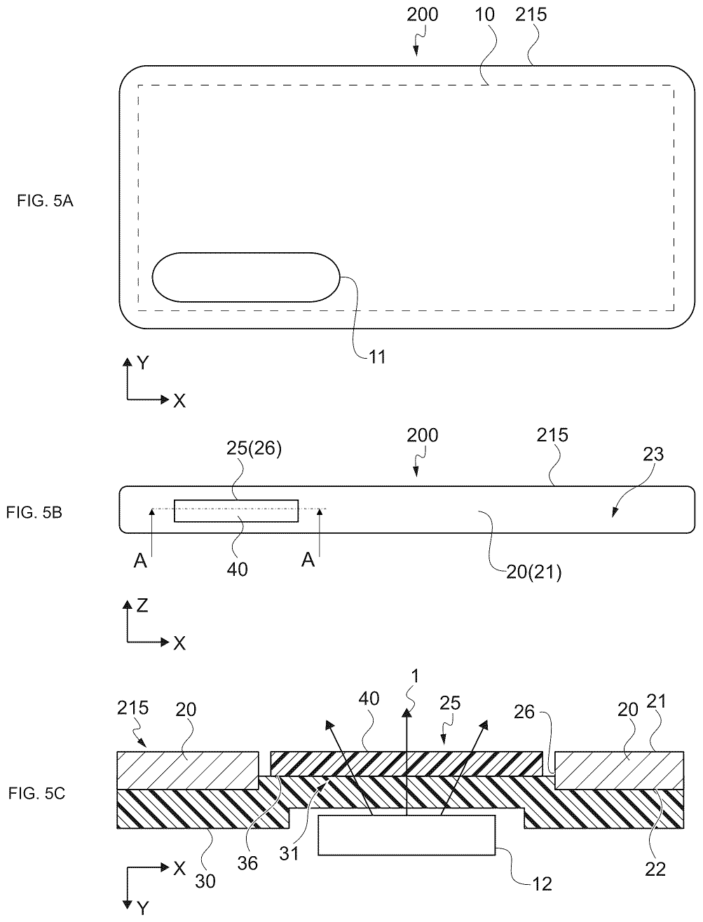

FIG. 5 is a schematic view showing a configuration example of the communication apparatus according to the second embodiment. A of FIG. 5 is a plan view as a communication apparatus 200 is viewed from the back surface. B of FIG. 5 is a plan view as the communication apparatus 200 is viewed from the side surface. C of FIG. 5 is a cross-sectional view of the communication apparatus 200, which is taken along the AA line shown in B of FIG. 5. Here, as mainly shown in C of FIG. 5, a cross-sectional structure of a case 215 constituting the communication apparatus 200 is different from the above-mentioned embodiment.

In the present embodiment, the base part 31 of the reinforcing member 30 covers the through-window 25 from the inside. Hereinafter, a surface in the outside of the base part 31 covering the through-window 25 will be referred to as a connection surface 36. In the example shown in C of FIG. 5, the flat connection surface 36 is, inside the through-window 25, formed at a constant depth as viewed from the external surface 21. Moreover, the inner peripheral surface 26 of the through-window 25 is exposed outside the connection surface 36.

It should be noted that the configuration of the base part 31 is not limited, and for example, the recess part as described with reference to C of FIG. 1 may be provided and a structure to cover the inner peripheral surface 26 of the through-window 25 may be used.

The cover part 40 is formed as a component separate from the reinforcing member 30 and attached to the connection surface 36 of the base part 31. For example, with an adhesion agent or an adhesion seal, the cover part 40 and the connection surface 36 are bonded to each other. Moreover, for example, the cover part 40 and the connection surface 36 may be attached via a fitting portion. In addition, the cover part 40 may be screwed inside the base part 31.

In this manner, the cover part 40 is an attachable component attached to the case 215 to cover the through-window 25 from the outside.

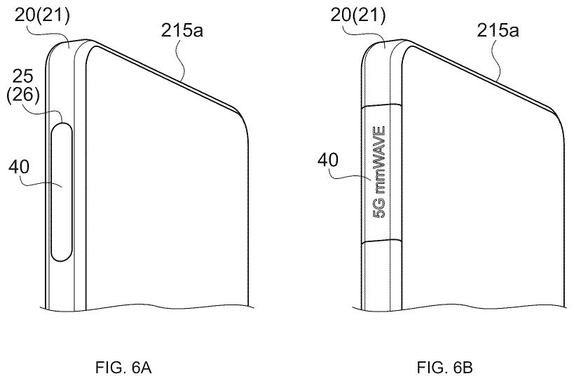

FIG. 6 is a schematic view showing a configuration example of the cover part 40 attached to the metallic casing 20.

In a case 215a shown in A of FIG. 6, the through-window 25 whose both ends have a semi-circular shape is configured and the cover part 40 having a shape similar that of the through-window 25 is attached to the inside of the through-window 25. A surface in the outside of the cover part 40 is subjected to decorative machining such as printing, coating, or vapor deposition to make the cover part 40 made of a resin similar to metal. In this manner, decorating the cover part 40 enables it to match the color and texture of the metallic casing 20. Moreover, due to the clearance between the through-window 25 and the cover part 40, the cover part 40 can be designed like a button, for example. In addition, it is unnecessary to make the color and texture of the cover part 40 match the metallic casing 20. For example, a design in which the color and texture of the cover part 40 are made different from those of the surrounding metallic casing 20 on purpose.

In a case 215b shown in B of FIG. 6, the cover part 40 having a width substantially equal to the width of the case 215b in the front-rear direction (Z direction) is attached. The cover part 40 is configured to be larger than the through-window 25 and is configured to cover the entire through-window 25 from the outside. In this configuration, for example, a portion of the metallic casing 20 in which the through-window 25 is formed is machined to be thinner than the other portion and the cover part 40 is attached thereto to cover the entire portion machined to be thinner.

Such a design to show the presence of the through-window 25 for the communication waves 1 to pass therethrough by increasing the size of the cover part 40 on purpose may be employed. For example, as shown in B of FIG. 6, the letters or logo, e.g., “5G mmWAVE,” may be formed outside the cover part 40.

### Other Embodiments

The present technology is not limited to the above-mentioned embodiments, and various other embodiments can be realized.

Hereinabove, the configuration in which the through-window is formed on the side surface of the communication apparatus has been described. The position of the through-window is not limited, and for example, the through-window may be provided on the back and front surfaces of the communication apparatus.

The communication apparatus is often provided with an antenna module for the back surface or the like other than the antenna module for the side surface. For example, in the configuration using the back glass, the communication waves can pass through the back glass, and therefore it is unnecessary provide a through-window and the like. On the other hand, in a case where the back surface is formed by the metallic casing with no back glass, suitable communication can be performed by providing a through-window in the back surface. Also in such a case, the use of the cover part according to the present technology enables for example the through-window to be closed in an unremarkable manner.

Hereinabove, the configuration in which the metallic casing is exposed in the entire case has been described. Not limited thereto, the metallic casing may be coated. In this case, for example, the cover part is configured in accordance with the coated metallic casing. By coating the metallic casing occupying a large portion of the outer appearance of the case, a wide variety of colors and textures can be easily realized.

At least two of the features of the present technology described above can also be combined. That is, various features described above in the respective embodiments may be arbitrarily combined across the respective embodiments. Moreover, the above-mentioned various effects are merely exemplary, not limitative, and other effects may be provided.

In the present disclosure, “the same,” “equal,” “orthogonal,” and the like are concepts including “substantially the same,” “substantially equal,” “substantially orthogonal,” and the like. For example, states included in a predetermined range (e.g., ±10% range) based on “completely the same,” “completely equal,” “completely orthogonal,” and the like are also included.

It should be noted that the present technology can also take the following configurations.

(1) A communication apparatus, including:
a metallic casing in which a through-window for communication waves to pass therethrough is formed;
a non-metallic member that is provided inside the metallic casing and reinforces the metallic casing; and
a cover part made of a resin that is formed separately from the non-metallic member and arranged exposed as viewed from outside of the metallic casing to cover the through-window.
   (2) The communication apparatus according to (1), in which
the non-metallic material is made of a resin, and
the resin that makes the cover part is a resin different from the resin that makes the non-metallic material.
   (3) The communication apparatus according to (2), in which
the resin that makes the non-metallic material is a reinforced resin including a glass filler, and
the resin that makes the cover part is a resin including no glass filler.
   (4) The communication apparatus according to (1) to (3), in which
the metallic casing and the cover part each have a machined surface obtained by integrally machining a surface shape thereof.
   (5) The communication apparatus according to (4), in which
the machined surface has a plurality of parallel grooves.
   (6) The communication apparatus according to any one of (1) to (5), in which
the non-metallic member has a base part formed to cover the through-window, and
the cover part is connected to outside of the base part.
   (7) The communication apparatus according to (6), in which
the base part has a recess part formed in the outside of the base part, and
the cover part is formed in the recess part.
   (8) The communication apparatus according to (7), in which
the base part is formed to cover an inner peripheral surface of the through-window.
   (9) The communication apparatus according to (7) or (8), in which
the cover part is formed by injection-molding a resin material in the recess part.
   (10) The communication apparatus according to any one of (6) to (9), in which
the cover part is attached to the outside of the base part.
   (11) The communication apparatus according to any one of (1) to (10), in which
the metallic casing has an external surface that is a surface in the outside and a metallic surface is exposed in at least a portion of the external surface.
   (12) The communication apparatus according to any one of (1) to (11), further including
an antenna module that performs communication by the communication waves, in which
the through-window is provided at a position to face the antenna module.
   (13) The communication apparatus according to any one of (1) to (12), in which
the metallic casing is a frame constituting a flat-plate shaped apparatus and has a side surface part that constitutes a side surface of the flat-plate shaped apparatus, and
the through-window is formed in the side surface part.
   (14) The communication apparatus according to any one of (1) to (13), in which
the communication waves are electromagnetic waves whose frequencies are in an inclusive range of from 10 GHz to 300 GHz.
   (15) A case for a communication apparatus, including:
a metallic casing in which a through-window for communication waves to pass therethrough is formed;
a non-metallic member that is provided inside the metallic casing and reinforces the metallic casing; and
a cover part made of a resin that is formed separately from the non-metallic member and arranged exposed as viewed from outside of the metallic casing to cover the through-window.

### REFERENCE SIGNS LIST

1 communication waves
10 communication apparatus main body
12 antenna module
15, 15a, 15b, 15c, 215, 215a, 215b case
17 machined surface
18 parallel groove
20 metallic casing
21 external surface
23 side surface part
25, 25a, 25b, 25c through-window
26 inner peripheral surface
30 reinforcing member
31 base part
32 recess part
40 cover part
100, 200 communication apparatus

1. A communication apparatus, comprising:
a metallic casing in which a through-window for communication waves to pass therethrough is formed;
a non-metallic member that is provided inside the metallic casing and reinforces the metallic casing; and
a cover part made of a resin that is formed separately from the non-metallic member and arranged exposed as viewed from outside of the metallic casing to cover the through-window.

2. The communication apparatus according to claim 1, wherein
the non-metallic material is made of a resin, and
the resin that makes the cover part is a resin different from the resin that makes the non-metallic material.

3. The communication apparatus according to claim 2, wherein
the resin that makes the non-metallic material is a reinforced resin including a glass filler, and
the resin that makes the cover part is a resin including no glass filler.

4. The communication apparatus according to claim 1, wherein
the metallic casing and the cover part each have a machined surface obtained by integrally machining a surface shape thereof.

5. The communication apparatus according to claim 4, wherein
the machined surface has a plurality of parallel grooves.

6. The communication apparatus according to claim 1, wherein
the non-metallic member has a base part formed to cover the through-window, and
the cover part is connected to outside of the base part.

7. The communication apparatus according to claim 6, wherein
the base part has a recess part formed in the outside of the base part, and
the cover part is formed in the recess part.

8. The communication apparatus according to claim 7, wherein
the base part is formed to cover an inner peripheral surface of the through-window.

9. The communication apparatus according to claim 7, wherein
the cover part is formed by injection-molding a resin material in the recess part.

10. The communication apparatus according to claim 6, wherein
the cover part is attached to the outside of the base part.

11. The communication apparatus according to claim 1, wherein
the metallic casing has an external surface that is a surface in the outside and a metallic surface is exposed in at least a portion of the external surface.

12. The communication apparatus according to claim 1, further comprising
an antenna module that performs communication by the communication waves, wherein
the through-window is provided at a position to face the antenna module.

13. The communication apparatus according to claim 1, wherein
the metallic casing is a frame constituting a flat-plate shaped apparatus and has a side surface part that constitutes a side surface of the flat-plate shaped apparatus, and
the through-window is formed in the side surface part.

14. The communication apparatus according to claim 1, wherein
the communication waves are electromagnetic waves whose frequencies are in an inclusive range of from 10 GHz to 300 GHz.

15. A case for a communication apparatus, comprising:
a metallic casing in which a through-window for communication waves to pass therethrough is formed;
a non-metallic member that is provided inside the metallic casing and reinforces the metallic casing; and
a cover part made of a resin that is formed separately from the non-metallic member and arranged exposed as viewed from outside of the metallic casing to cover the through-window.
